(19) United States
(12) Patent Application Publication
(10) Pub. No.: US 2026/0008361 A1
(43) Pub. Date: Jan. 8, 2026

(54) BATTERY UNIT AND METHODS

(71) Applicant: AUTOTECH ENGINEERING S.L., Amorebieta-Etxano (ES)

(72) Inventors: Carlos GARRIDO BETÉS, Sant Esteve Sesrovires, Barcelona (ES); Iolanda ARIAS GES, Sant Esteve Sesrovires, Barcelona (ES); María GIMÉNEZ GUANTER, Sant Esteve Sesrovires, Barcelona (ES)

(21) Appl. No.: 19/112,167

(22) PCT Filed: Sep. 29, 2023
(86) PCT No.: PCT/EP2023/077170

§ 371 Date: Mar. 14, 2025

(30) Foreign Application Priority Data
Sep. 30, 2022 (EP) 22382911.0

(51) Int. Cl. B60L 50/64; B60K 1/04

(52) U.S. Cl. CPC B60L 50/64; B60K 1/04; B60K 2001/0438

(57) ABSTRACT

The present disclosure relates to a battery unit (100) for an electric vehicle. The battery unit (100) comprises a battery tray (1) made of a composite material and defining an interior space configured to receive a battery (2) comprising one or more battery cells. The interior space is delimited by a bottom wall (3) and one or more lateral walls (4). Further, the lateral walls (4) comprise a side flange (5) extending outwardly from the lateral walls (4), and the side flange (5) comprises one or more embedded metal inserts (6). The metal inserts (6) are configured to receive one or more fasteners to secure the battery tray (1) to a load bearing structure of the electric vehicle. The present disclosure further relates to methods (500) for manufacturing a battery unit.

The present application claims the benefit of European patent application no EP22382911.0 filed on Sep. 30, 2022. The present disclosure relates to battery units for vehicles. More particularly, the present disclosure relates to battery units comprising a battery tray made of composite material. The present disclosure further relates to methods for manufacturing such battery units.

### BACKGROUND

Vehicles such as cars incorporate a structural skeleton designed to withstand all loads that the vehicle may be subjected to during its lifetime. The structural skeleton or “Body In White” (BIW) is further designed to withstand and absorb impacts, in case of e.g. collisions with other cars. The structural skeleton is also designed to be as lightweight as possible in order to reduce the emission of pollutants such as CO₂ to the environment or to reduce the consumption of electricity in an electric vehicle.

The structural skeleton or BIW of a car may for instance include bumpers, pillars (e.g. A-pillar, B-pillar, C-pillar), side impact beams and rocker panels. These and other structural members may have one or more regions with a substantially U-shaped (also known as “hat”-shaped) cross section. These structural members may be manufactured in a variety of ways and may be made of a variety of materials. For instance, rocker panels may be made of steel, particularly Ultra-High Strength Steels (UHSS) and may be manufactured through press hardening.

Ultra-High Strength Steels (UHSS) exhibit optimized maximum strength per weight unit and advantageous forming properties in the automotive industry, for the structural framework of the vehicle or at least a number of its components. In the present disclosure, an UHSS may be regarded as a steel with a maximum tensile strength (after hot stamping) of at least 1000 MPa, preferably up to about 1500 MPa or up to 2000 MPa or more. An example of an UHSS used in the automotive industry is 22MnB5 steel.

Processing a component for a vehicle may comprise forming of a metal plate, in particular a steel plate, in order to give the plate a desired shape. One process that is used particularly in the automotive industry is Hot Forming Die Quenching (HFDQ). In the HFDQ process, a steel blank is heated to above an austenization temperature, above Ac1 or above Ac3. After heating to above the austenization temperature, the blanks are placed in a hot forming press. The blanks are deformed and at the same time are quenched (rapidly cooled down). Cooling down may typically occur at a rate that is higher than a so-called critical cooling rate.

The rapid development of electric vehicles (EVs) and hybrid vehicles has forced the industry to design new car components, e.g. for weight reduction to achieve improved vehicle range, and for accommodating and protecting new car components among others. Structural components with new geometries and alternative materials are being manufactured and integrated into EVs to accomplish safety and weight reduction goals.

Traction batteries are an essential part of the EVs and hybrid vehicles which provide power to an electric motor of the vehicle. The electronic and chemical nature of these batteries makes them particularly sensitive to high mechanical loads, e.g. crash impacts. To extend battery lifespan and protect them against external collisions, the automotive industry has put considerable effort to provide battery enclosures and load bearing structures suitable for EVs. Thus, a wide range of protection elements has been designed and engineered during the last years to accommodate and protect traction batteries.

Steel battery boxes or battery trays have been designed for that purpose. Also polymeric (plastic) or composite components have been developed. Although plastics and composites may be lighter than metallic components, they need to be designed and dimensioned for protection against severe impacts.

The present disclosure aims to provide improvements in the structures for protection of a battery for cars.

### SUMMARY

In a first aspect, a battery unit for a vehicle is provided. The battery unit comprises a battery tray made of a composite material. The battery tray defines an interior space configured to receive a battery comprising one or more battery cells. The interior space of the battery tray is delimited by a bottom wall and one or more lateral walls. Further, the lateral walls comprise a side flange extending outwardly from the lateral walls. In addition, the side flange comprises one or more metal inserts embedded in the side flange. The metal inserts are configured to receive one or more fasteners to secure the battery tray to a load bearing structure of the electric vehicle.

The composite battery tray provides a lightweight structure for the battery unit disclosed. Further, the composite material may be chosen to provide tailored mechanical strength, e.g., the composite material may provide higher strength in one direction than in other direction. Additionally, the introduction of metal inserts embedded in a side flange of the battery tray provides a robust connection point between the battery tray and other structures of the electric vehicle, such as a load bearing frame surrounding the battery tray or a(nother) part of the vehicle framework. Thus, the battery unit provided has the lightness benefit from units made of composite or polymer materials, whereas at the same time it provides a secure connection between components, which allows transferring mechanical loads through load bearing structures.

Throughout the present disclosure, “electric vehicles” or “hybrid vehicles” may be understood to encompass any vehicle having a battery at least partially configured to provide power to an electric power train of the vehicle.

Also, throughout the present disclosure, references to the “mechanical properties of a structure” may be understood as the mechanical properties of the material forming said structure. Therefore, unless otherwise stated, comparisons of mechanical properties of structures, components, or others, are directed to the material and not to the geometry, or other particularities, of the same.

In examples, the composite material used to form the battery tray may comprise glass fiber, although other materials such as carbon fiber, or aramid fibers may also be used.

In some examples, the battery tray may be made of a sheet molding compound. The sheet molding compound is a composite material provided in sheet form. The sheet is generally made by extending a resin paste into a surface, over which chopped fibers are dispensed. Then, another layer of resin is added on top of the chopped fibers and the sheet is compacted and stored while it cures.

In examples, the metal inserts are plates comprising at least two fastener holes. The fastener holes may be configured to receive the fasteners and secure the battery tray to a load bearing structure of the electric vehicle. Thus, the holes may act as connection points between the plates and the load bearing structure, and may limit the forces and torques experienced by the battery tray in case of an impact.

In some examples, the metal inserts may be perforated. The strength of the composite-metal plate connection may be enhanced by the perforations, i.e. the composite material may at least partially flow into the perforations and cure inside, increasing the contact surface between components and generating solid bridges of composite material between the two sides of the metal plates.

In examples, the metal inserts comprise at least one pin protruding perpendicularly from a surface of the side flange. The pin may serve as an additional contact point between the metal insert and other components of the battery unit, e.g. a fixation bracket. A pin may herein be understood to cover any structural element used for fastening things together or as a support by which one thing may be suspended from another. A pin may be embodied herein as e.g. a stud or rod, or bolt.

In examples, the battery unit may further comprise a load bearing frame. Further, the load bearing frame may comprise structural elements made of aluminum. These structural elements may be relatively light and may provide support and protection to the battery tray.

In some examples, the battery tray may further comprise reinforcement ribs located at the bottom wall. In examples, the reinforcement ribs may define a substantially cartesian grid. The ribs may increase the rigidity of the tray and may also promote air circulation between the bottom wall and the battery.

In examples, the battery unit may further comprise one or more fixation brackets configured to be coupled with the metal inserts and to at least partially retain one or more of the battery cells in the interior space. The fixation bracket may therefore be understood as a component of the battery unit configured to at least partially cover the interior space of the battery tray and to limit the motion of the battery by geometric interference. The fixation bracket may also reduce vibration of the battery inside the battery tray.

In some examples, the fixation brackets may comprise internal channels configured to conduct a cooling medium. Further, the fixation brackets may comprise an aluminum profile extending into the interior space where the internal channels may be located. Thus, the fixation bracket with cooling channels can help to maintain the battery in a suitable temperature range.

In examples, the aluminum profiles may be configured to be located adjacent to battery cells or between battery cells.

In some examples, the fixation brackets comprise at least one fixation segment configured to receive the pins of the metal inserts. The fixation segments may be substantially horizontal. Thus, the fixation brackets may be connected to a load bearing structure through the metal inserts. This configuration allows transferring loads from the load bearing structure or frame to the fixation brackets, without the composite battery tray having to withstand high mechanical loads.

Further, in examples, the fixation segments are configured to be joined together by aluminum profiles. Thus, the fixation brackets may have fixation segments around the periphery of the battery cells.

In some examples, the battery unit may comprise a central separator bracket configured to be located between rows of battery cells. The central separator may be configured to limit the motion of the battery by geometric interference, and may include inner channels to conduct a cooling medium for battery cooling.

In another aspect, a method for manufacturing a battery unit of an electric vehicle is provided. The method comprises providing a plurality of metal inserts in a mold. Further, the method comprises providing a sheet molding compound in the mold. Then, the method comprises forming the battery unit by hot compression molding. Note that the first and second steps of the method may be carried out in the order above or in reverse order.

According to this aspect, the method provided allows generating a battery unit in a single forming step. This allows integrating the metal inserts into the composite material, which provide additional strength to the battery tray. Additionally, the resulting battery unit is lighter than an analogous battery unit primary made of metal, and it still provides enough rigidity to withstand the weight and other mechanical loads associated with the battery. Further, the method disclosed allows manufacturing a battery unit in a fast and inexpensive manner. In addition, this method allows using an at least partially recycled composite material, contributing to reduce global CO₂ emissions.

In some examples of the method, forming the battery tray may comprise heating the mold between 100 to 160° C. Further, the battery tray may be formed by applying a pressure of between 30 to 120 bar to the sheet molding compound. In addition, the sheet molding compound may comprise glass fiber.

Throughout this disclosure a rib may be understood as an elongated, substantially straight part of a battery tray for local reinforcement. The ribs may be manufactured during forming the battery tray by hot compression molding or may be included in the battery tray after this has been manufactured. The ribs may be made of composite material or may be made of any other material and embedded in the composite during forming the battery tray.

### BRIEF DESCRIPTION OF THE DRAWINGS

Non-limiting examples of the present disclosure will be described in the following, with reference to the appended figures, in which:

FIG. 1 schematically illustrates a perspective top view of an example of a battery unit according to the present disclosure;

FIG. 2 schematically illustrates a perspective top view of the battery tray in FIG. 1;

FIG. 3 schematically illustrates a perspective top view of an example of a metal insert;

FIG. 4 schematically illustrates a cross-section across the width of the battery unit in FIG. 1; and

FIG. 5 is a flow chart of a method for manufacturing a battery unit according to the present disclosure.

The figures refer to example implementations and are only be used as an aid for understanding the claimed subject matter, not for limiting it in any sense.

### DETAILED DESCRIPTION OF EXAMPLES

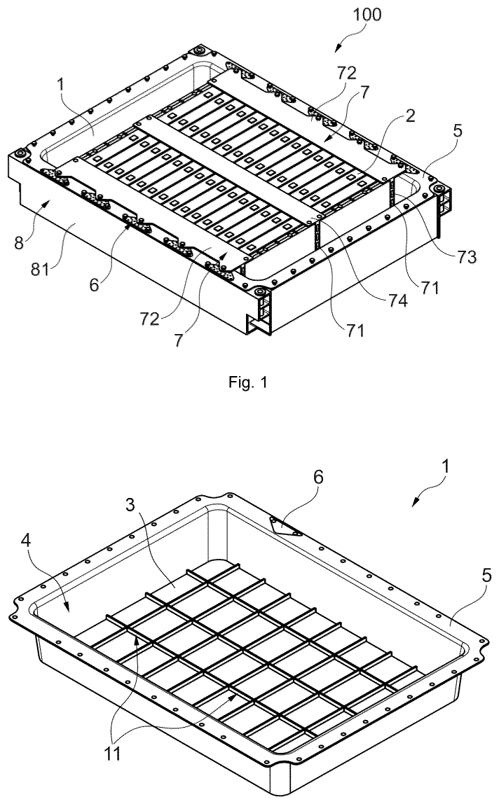

FIG. 1 schematically represents a battery unit 100 for a vehicle, particularly an electric vehicle or hybrid vehicle.

The battery unit 100 comprises a battery tray 1 made of a composite material. The battery tray 1 defines an interior space configured to receive a battery 2 comprising one or more battery cells. The interior space of the battery tray 1 is delimited by a bottom wall 3 and at least one lateral wall 4. Further, the lateral wall 4 comprises a side flange 5 extending outwardly from the lateral wall 4. In addition, the side flange 5 comprises one or more metal inserts 6 embedded in the side flange 5. Furthermore, the metal inserts 6 are configured to receive one or more fasteners to secure the battery tray 1 to a load bearing structure of the electric vehicle.

The battery tray 1 provided, which is made of composite material and can thus be relatively lightweight. Further, the composite material may be chosen and tailored to provide specific mechanical properties to the battery tray 1. For example, the composite material may comprise a layer of biaxial or triaxial fibers to increase the mechanical properties of the tray in a particular direction. Additionally, the material of the fibers and the resin may also be chosen to obtain a final product, i.e. battery tray 1, with specific mechanical properties. For example, the fibers may comprise glass fibers, carbon fibers or aramid fibers among others. In some examples, different types of fibers may be incorporated in the same tray.

Additionally, the metal inserts 6 embedded in a side flange 5 of the battery tray 1 provide additional local strength to the battery tray 1. More specifically, the metal inserts 6 may transfer the loads acting on the battery unit 100 through relatively high strength components, limiting the magnitude of loads acting on the composite battery tray 1. The metal inserts 6 may be made of steel.

Further, the example of the battery unit 100 illustrated in FIG. 1 shows that the battery unit 100 may also comprise a load bearing frame 8 comprising structural elements 81. The load bearing frame 8 may substantially completely surround the battery tray. In this example, the load bearing frame 8 may include two longitudinal transverse members joined to two transverse members.

The load bearing frame 8 may provide additional protection to the battery tray (and the battery inside) against external impacts, e.g. side collisions. Additionally, the structural elements 81 may provide protection at a relatively low weight, e.g. the structural elements 81 may be aluminum extruded profiles with low average density.

In addition, the load bearing frame 8 may also aid in the integration of the battery unit 100 in EVs. For example, the load bearing frame 8 may comprise connection points to the body in white of the EV.

Further, the example of the battery unit 100 in FIG. 1 comprises a fixation bracket 7 configured to be coupled with the metal inserts 6. The fixation bracket 7 is configured to at least partially retain one or more of the battery cells in the interior space of the battery tray 1. The fixation bracket 7 may be made of a metal, e.g. stainless steel or aluminum.

In some examples, the fixation bracket 7 may comprise fixation segments 72 or flanges configured to receive pins 62 of the metal plates 6 (this will be explained further with reference to FIG. 3).

The fixation brackets 7 in the illustrated example comprise a substantially vertical portion 71, and a substantially horizontal flange or fixation segment 72. The flange or fixation segment 72 may extend inwards to retain cells of the battery.

Further, as illustrated in FIG. 1, the fixation bracket 7, and in particular the vertical portion 71 may comprise internal channels 73 configured to conduct a cooling medium. The cooling medium may be water and/or glycol or another suitable heat exchange liquid. The fixation bracket 7 may extend into the interior of the tray next to a row of cells of the battery, i.e. between a side wall of the tray and a row of cells. The internal cooling channels may extend generally parallel to each other in a longitudinal direction.

In examples, the fixation bracket may be made by extrusion, e.g. aluminum extrusion. The extruded profiles can incorporate the cooling channels.

Further, in some examples, the battery unit 100 may comprise a central separator bracket 74 configured to be located between rows of battery cells, i.e. both sides of the separator bracket 74 may be adjacent to a battery cell.

Thus, in some examples, the battery unit 100 may comprise aluminum profiles 71 at least partially surrounding the battery 2, and a central separator bracket 74 between battery cells. In the illustrated example, the battery unit 100 includes two rows of cells in the battery tray. The central separator bracket 74 may be arranged between the two parallel rows. In the illustrated example, the central separator bracket 74 may comprise a horizontal portion, or horizontal flange which aids in retaining the cells of the battery.

It should be clear that the vertical separation between brackets 74 and the cells of the battery is illustrated in an exaggerated manner in FIG. 4.

The central separator bracket 74 may comprise internal cooling channels in a manner similar to what was described for the fixation brackets 7. The arrangement of the vertical portion or profiles 71 and central separator bracket 74 with respect to the battery cells may be seen in more detail in FIG. 4.

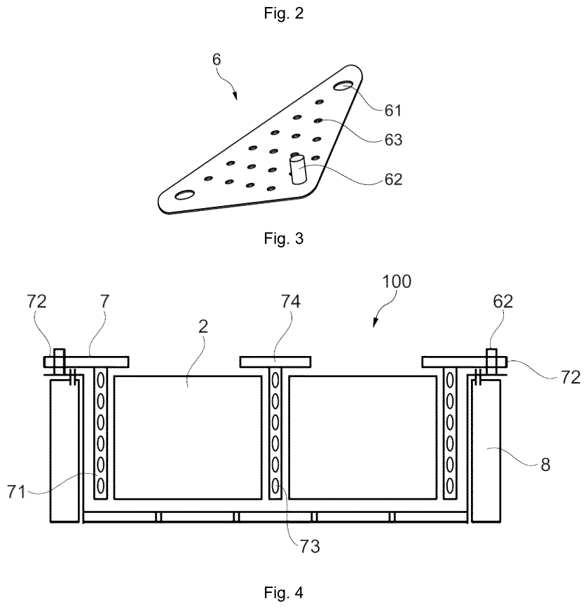

FIG. 2 is a schematic illustration of the battery tray 1 of the battery unit 100 of FIG. 1. As previously discussed, the battery tray 1 defines an interior space delimited by a bottom wall 3 and at least one or more lateral walls 4. In this example, the battery tray is rectangular and comprises four lateral walls 4, but battery trays 1 with other geometries can also be provided.

The battery tray 1 in the example of FIG. 2 also shows that the lateral walls 4 comprise a side flange 5 where one or more metal inserts 6 are embedded. In the illustrated example, all four lateral walls 4 comprise a side flange 5, but in other examples some of the lateral walls 4 may not comprise a side flange 5.

The composite battery tray 1 may be manufactured using compression molding or sheet molding compound. In this case, a sheet molding compound (SMC) may be cut into a sheet of appropriate size and located into a heated die of a mold. In examples, the heated die may be at a temperature between 100 and 160° C. The die(s) of the mold may then be brought together and closed exerting a pressure of between 30 and 120 bar. Thus, as material viscosity drops, the SMC flows and fills the mold cavity. Note that other techniques for which the pressure applied to the SMC is considerably lower, i.e. below 30 bar, may also be used.

SMCs made of fiber glass may be cured in between 30 seconds and 150 second after starting the forming process. Therefore, the overall manufacturing cycle can be as fast as 80 seconds including the loading and unloading movement of the parts, allowing high-volume production at a reduced material cost.

The composition of the SMC may be adapted to provide composite materials with improved properties. For example, other fibers can be introduced in the SMC to increase strength-and stiffness-to-weight ratio. Further, other additives may be also provided to prevent surface microcracks due to outgassing.

Different types of thermoset resins may be used, e.g. polyester resin, vinyl ester resin, epoxy resin or poly (methyl methacrylate) (PMMA). Not only can fiber reinforced composites provide a relatively lightweight structure, they can also act as electrical insulation if suitable materials (and particularly suitable resin) are used.

It is noted that the battery tray 1 in the example of FIG. 2 also includes reinforcement ribs 11 located at the bottom wall 3. The ribs 11 may provide stiffness to the bottom of the tray. The ribs 11 may be integrally formed with the battery tray 1. For example, the mold used to manufacture the battery tray may include a suitable geometry and the ribs may be formed by composite material.

The reinforcement ribs 11 in this example define a substantially cartesian grid to provide rigidity in two perpendicular directions, e.g., a longitudinal and a traverse direction.

The reinforcement ribs 11 may also provide a gap between the bottom wall and the battery 2, and therefore they may enhance air flow circulation and battery cooling. Further, the height of the reinforcement ribs 11 may be chosen such that the battery 2, when lying on them, is substantially aligned with the side flanges 5.

In other examples, the composite battery tray 1 may be manufactured by hand layup, which consists of placing layers of either dry fabrics, by hand onto a tool (mold) to form a laminate stack. Then, resin can be applied to the dry fabrics e.g., by means of resin infusion or injection using resin transfer molding (RTM). In further examples, prepregs (fabric pre-impregnated with resin) may be used. After laying of prepreg, they may be heated and cured.

In other cases, the manufacturing process may comprise laying fabrics already coated with resin, and then debulk the stack. The debulking can be done by hand with rollers or using a vacuum-bagging technique.

FIG. 3 schematically illustrates a perspective top view of an example of a metal insert 6. In this example, the metal insert 6 is a plate comprising two fastener holes 61 to connect the metal insert 6 with other components of the battery unit 100, and more precisely to connect with the load bearing frame 8 illustrated in FIG. 1.

The metal insert 6 illustrated in this example defines a substantially triangular shape with two fastener holes 61 at the vertices of the longest side and a pin 62 protruding perpendicular to the surface of the metal insert 6. In other examples, the metal insert 6 may have the fastener holes 61 and the pin 62 distributed in a different manner. For example, the metal insert 6 may have three fastener holes located substantially at the vertices of the triangular shape and the pin 62 in a substantially central location. It is noted that the pin 62 may be configured to protrude perpendicular from a surface of the side flange 5 to engage with the fixation bracket 7 of the battery unit 100.

Pin 62 may be a simple rod, or in other examples may be configured e.g. as a stud or bolt.

Also illustrated in FIG. 3, the metal plates may be perforated plates. Perforations herein may be understood to be through-holes which may generally be smaller than the fastener holes. The strength of the bond between the metal plate 6 and the battery tray 1 may be enhanced by the perforations 63, i.e. the composite material of the battery tray 1 may at least partially flow into the perforations 63 and cure inside, increasing the contact surface between components and generating solid bridges of composite material between the two sides of the metal plates The bond may thus not only be chemical but also mechanical. In other examples, and also to strengthen the metal plate-battery tray connection, the metal plates 6 may comprise surface ridges or surface indentations.

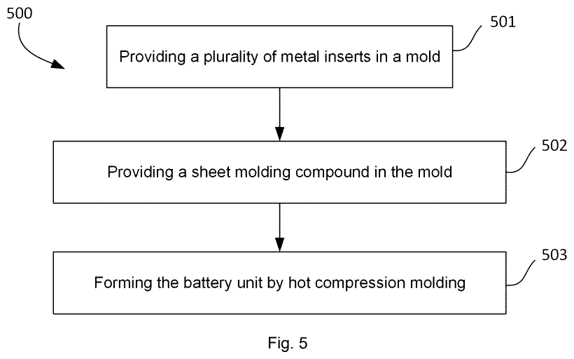

FIG. 5 is a flow chart of a method 500 for manufacturing a battery unit 100 according to the present disclosure.

The method 500 comprises, at block 501, providing a plurality of metal inserts 6 in a mold. The method further comprises, at block 502, providing a sheet molding compound in the mold. Furthermore, the method comprises, at block 503, forming the battery tray 1 by hot compression molding.

As previously discussed, the method 500 provided allows manufacturing a battery unit 100 in a simple, fast and reliable manner. Further the method 500 may be easily automated for mass production, reducing human supervision and associated costs.

In examples, and as mentioned before, forming the battery unit 100 may comprise heating the mold between 100 to 160° C. and applying a pressure of between 30 to 120 bar to the sheet molding compound. In addition, the sheet molding compound may comprise glass fiber, which may result in an overall manufacture time of approximately 80 seconds.

Further, the method 500 may be adapted to form a battery unit 100 with any combination of the technical features previously discussed.

After manufacturing of the tray, a plurality of battery cells may be introduced into the tray. In the example of previous figures, two rows of battery cells are provided. Stopper elements may be arranged on both opposite ends of the rows of battery cells. Fixation brackets may be attached to the metal inserts along at least two sides of the battery tray.

The fixation brackets may be mechanically attached, e.g. screwed to the metal inserts. The fixation brackets may also be joined to the stopper elements, thereby they at least partially cover the battery cells and thereby retain the battery cells in place. Central separator bracket may be arranged in between the rows of cells and attached at both ends to the stopper elements.

Although only a number of examples have been disclosed herein, other alternatives, modifications, uses and/or equivalents thereof are possible. Furthermore, all possible combinations of the described examples are also covered. Thus, the scope of the present disclosure should not be limited by particular examples, but should be determined only by a fair reading of the claims that follow.

1. A vehicle comprising a battery unit, the battery unit comprising:
a battery tray made of a composite material and defining an interior space configured to receive a battery comprising one or more battery cells and, the interior space being delimited by a bottom wall and one or more lateral walls, wherein
the lateral walls comprise a side flange extending outwardly from the lateral walls, and wherein the side flange comprises one or more metal inserts embedded in the side flange, and
the battery unit further comprising a load bearing frame substantially completely surrounding the battery tray, and wherein
the metal inserts are configured to receive one or more fasteners to secure the battery tray to the load bearing frame.

2. The vehicle unit of claim 1, wherein the battery tray is made of a sheet molding compound.

3. The vehicle of claim 2, wherein the composite material comprises glass fiber.

4. The vehicle of claim 1, wherein the metal inserts are plates comprising at least two fastener holes.

5. The vehicle of claim 1, wherein the metal inserts are perforated plates.

6. The vehicle of claim 4, wherein the metal inserts comprise at least one pin protruding perpendicularly from a surface of the side flange.

7. The vehicle of claim 1, wherein the load bearing frame comprises structural elements made of aluminum.

8. The vehicle of claim 1, wherein the battery tray further comprises reinforcement ribs located at the bottom wall.

9. The vehicle of claim 1, the battery unit further comprising one or more fixation brackets coupled with the metal inserts, and least partially retaining one or more of the battery cells in the interior space.

10. The vehicle of claim 9, wherein the fixation brackets comprise a substantially horizontal fixation segment configured to receive pins of the metal inserts.

11. The vehicle of claim 9, wherein the fixation brackets further comprise internal channels configured to conduct a cooling medium.

12. The vehicle of claim 11, wherein the fixation brackets comprise a substantially vertical portion, and wherein the substantially vertical portion comprises the internal channels configured to conduct the cooling medium.

13. The vehicle of claim 1, further comprising a central separator bracket located between two rows of battery cells.

14. A method for manufacturing a battery unit of an electric vehicle, the method comprising:
providing a load bearing frame;
providing a plurality of metal inserts in a mold;
providing a sheet molding compound in the mold; and
forming a battery tray by hot compression molding, wherein
a battery tray defines an interior space configured to receive a battery comprising one or more battery cells and, the interior space being delimited by a bottom wall and one or more lateral walls, wherein
the lateral walls comprise a side flange extending outwardly from the lateral walls, and wherein the side flange comprises the metal inserts with fastener holes embedded in the side flange, and
the method further comprising:
arranging the load bearing frame around the battery tray and joining the load bearing frame to the battery tray inserting fasteners in the fastener holes of the metal inserts.

15. The method of claim 14, wherein forming the battery tray comprises heating the mold between 100 to 160° C. and applying a pressure of between 30 to 120 bar to the sheet molding compound, and wherein the sheet molding compound comprises glass fiber.

16. The method of claim 14, wherein the load bearing frame is made of aluminum.

17. The vehicle of claim 8, wherein the reinforcement ribs define a cartesian grid.

18. A battery unit for a vehicle, the battery unit comprising:
a battery tray made defining an interior space configured to receive a battery comprising one or more battery cells and,
a load bearing frame substantially completely surrounding the battery tray, wherein
the interior space of the battery tray is delimited by a bottom wall and one or more lateral walls, wherein
the lateral walls comprise a side flange extending outwardly from the lateral walls, and
wherein
the battery tray is made of a sheet molding compound including glass fiber, wherein the
side flange comprises one or more metal inserts embedded in the side flange, and wherein
the load bearing frame is joined to the metal inserts.

19. The battery unit of claim 18, further comprising one or more fixation brackets for retaining one or more of the battery cells in the interior space, wherein
the metal inserts comprise at least one pin protruding perpendicularly from a surface of the side flange, and, and wherein
the fixation brackets are coupled with respective pins of the metal inserts.

20. The battery unit of claim 19, wherein the fixation brackets further comprise internal channels configured to conduct a cooling medium.
